(19) United States
(12) Patent Application Publication
(10) Pub. No.: US 2018/0128943 A1
(43) Pub. Date: May 10, 2018

(54) IMAGING DEVICE PROVIDED WITH LENS HAVING MOTH-EYE STRUCTURE

(71) Applicant: DENSO CORPORATION, Kariya-city (JP)

(72) Inventors: Katsuhiko Hibino, Kariya-city (JP); Daisuke Takama, Kariya-city (JP)

(21) Appl. No.: 15/805,867

(22) Filed: Nov. 7, 2017

(30) Foreign Application Priority Data
Nov. 8, 2016 (JP) 2016-218058

(51) Int. Cl. G02B 1/118; G02B 27/00; G02B 7/02; H04N 5/225

(52) U.S. Cl. CPC G02B 1/118; H04N 5/2257; G02B 7/021; G02B 27/0018

(57) ABSTRACT

An imaging device mounted on a vehicle is provided. The imaging device includes an imaging element, a plurality of transparent members and a housing. The imaging element is configured to capture an object and output an image signal of the object. The plurality of transparent members includes at least one lens, and is arranged on a light transmission path of light that reaches the imaging element. The housing is configured to hold the imaging element and the plurality of transparent members. Moreover, the imaging device is provided with a moth-eye structure arranged on at least one surface among the plurality of transparent members.

### CROSS-REFERENCE TO RELATED APPLICATION

This application is based on and claims the benefit of priority from earlier Japanese Patent Application No. 2016-218058 filed Nov. 8, 2016, the description of which is incorporated herein by reference.

### BACKGROUND

### Technical Field

The present disclosure relates to an imaging device that captures an object. More particularly, the present disclosure relates to an imaging device provided with a lens having a moth-eye structure.

### Description of the Related Art

According to an imaging device using a plurality of lenses, it is required to reduce ghost and flare which may occur due to light reflection between lenses, in order to improve quality of captured images. In this respect, JP-A-2005-301172 discloses a technique in which a low reflection coating is applied to lenses.

However, an anti-reflection coating is not sufficient to suppress the reflection so that ghosting and flare are sufficiently reduced. In the case where the imaging device is mounted on a vehicle, areas having sources of ghost and flares such as the sun light, head lights of on-coming vehicles, rear lamps of a preceding vehicles and street lamps, have to be captured. Therefore, a problem arises that image quality is likely to decrease.

### SUMMARY

The present disclosure provides a technique that enhances quality of captured images.

According to a first aspect of the present disclosure is an imaging device mounted on a vehicle includes: an imaging element, a plurality of transparent members and a housing. The imaging element is configured to capture an object and output an image signal of the object. The plurality of transparent members includes at least one lens, and is arranged on a light transmission path of light that reaches the imaging element. The housing is configured to hold the imaging element and the plurality of transparent members. Moreover, the imaging device is provided with a moth-eye structure arranged on at least one surface among the plurality of transparent members.

According to the configuration thus configured, the moth-eye structure can suppress the light reflection on the surface of the transparent member. Hence, the quality of the captured image indicated by the image signal outputted by the imaging element can be improved such that ghost and flares are significantly reduced.

According to a second aspect of the present disclosure is an imaging device including an imaging element, at least one lens, at least either a barrel or a gap ring, and a housing. The imaging element is configured to capture an object and output an image signal of the object. The above-mentioned at least one lens is arranged on a light transmission path of light that reaches the imaging element. The housing is configured to hold the imaging element, at least one lens, and the barrel and gap ring. The imaging device has a moth-eye structure on an inner surface of at least either the barrel or the gap ring.

According to the above-described configurations, by using the moth-eye structure, light reflection can be suppressed on an inner surface of at least one of either the barrel or the gap ring. Hence, the quality of the captured image indicated by the image signal outputted by the imaging element can be improved such that ghost and flares are significantly reduced.

It should be noted that the bracketed reference signs in this column and in the claims indicate correspondence to specific means in the embodiments described later, and do not limit the technical scope of the present disclosure.

### BRIEF DESCRIPTION OF THE ©RAVINGS

In the accompanying drawings:

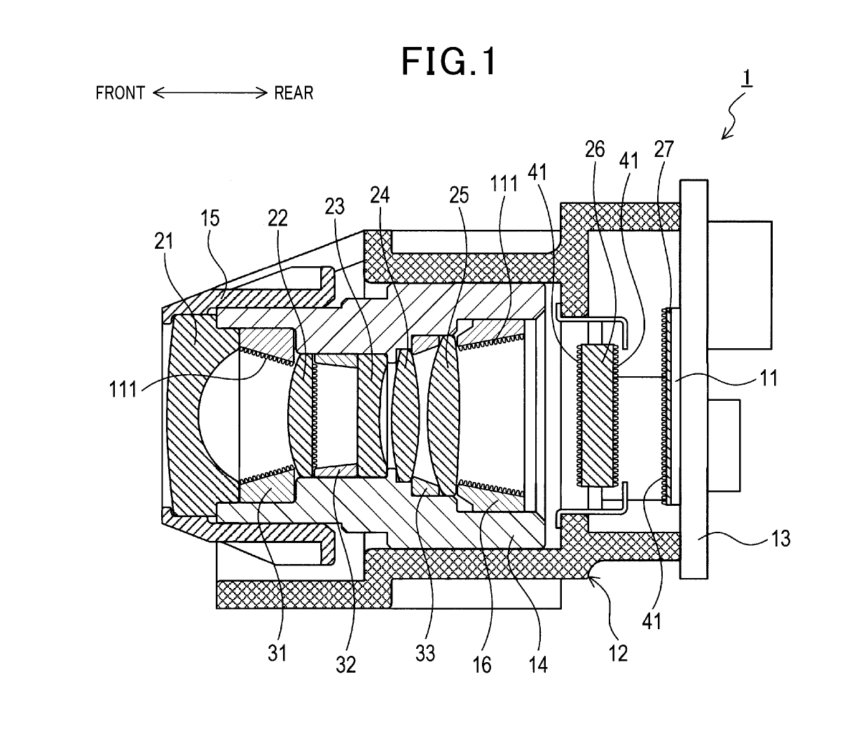

FIG. 1 is a cross-sectional view showing an overall imaging device of embodiments according to the present disclosure;

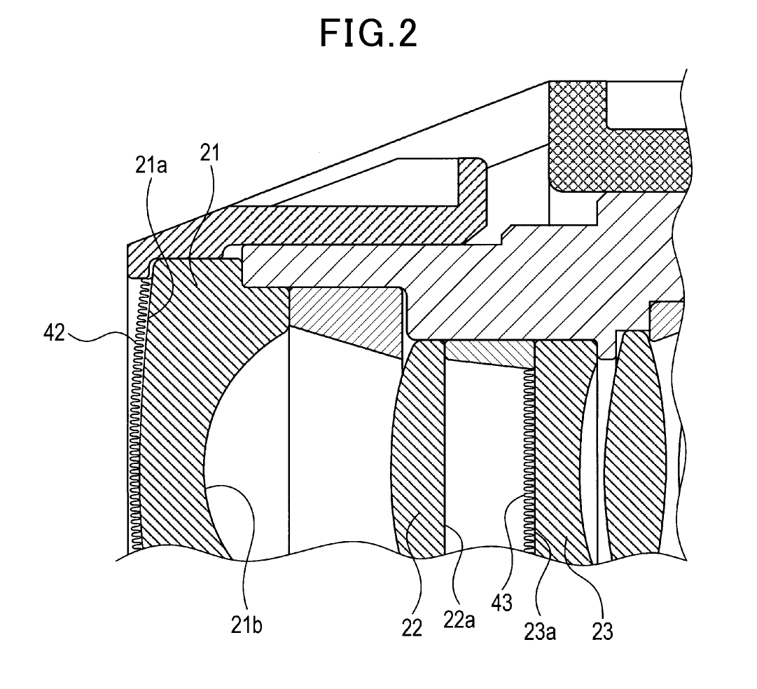

FIG. 2 is a cross sectional view showing an upper portion in the front part of the imaging device;

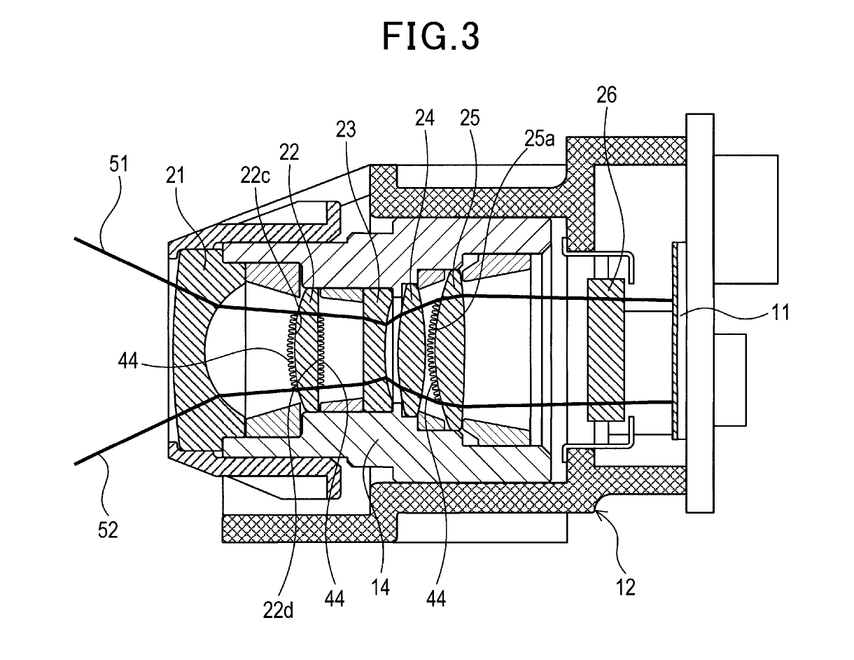

FIG. 3 is a cross sectional view showing an entire imaging device, and schematically showing a path of light that reaches the imaging element;

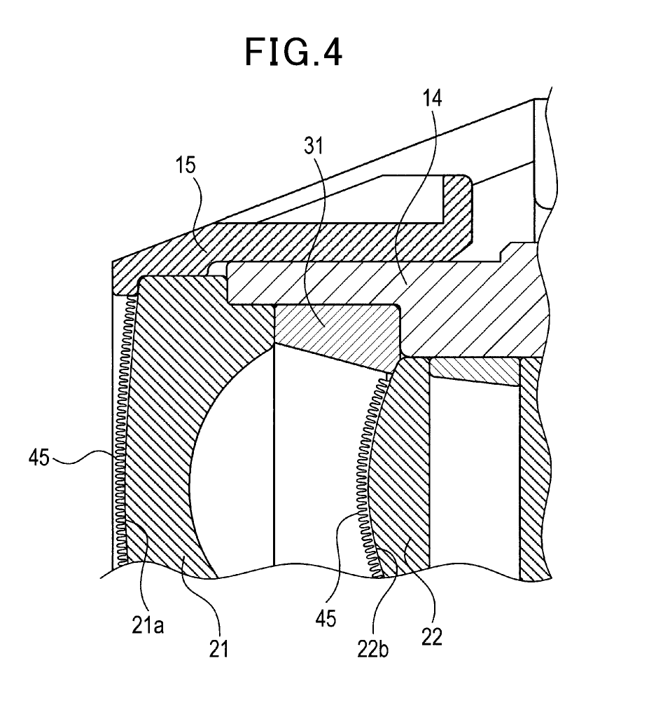

FIG. 4 is a cross sectional view showing an upper portion in the front part of the imaging device;

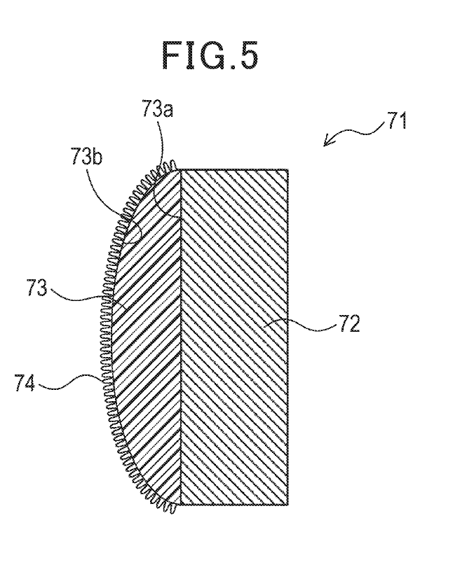

FIG. 5 is a schematic side view showing an example configuration of a lens;

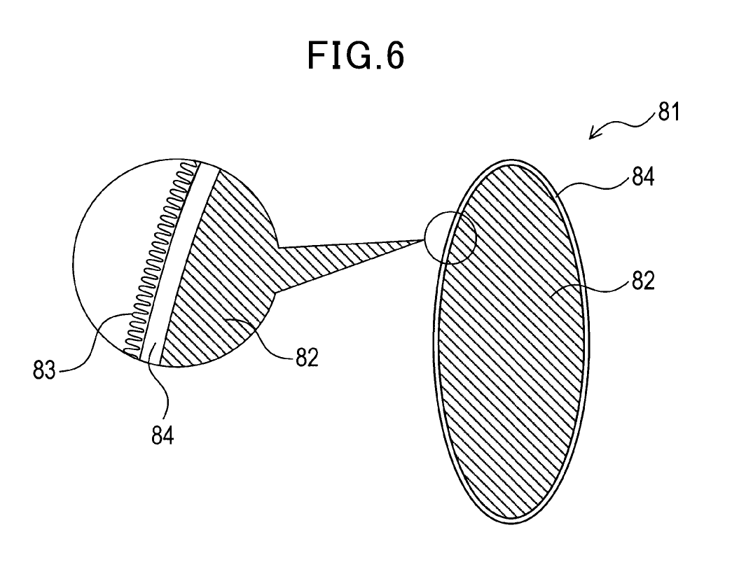

FIG. 6 is a schematic side view showing an example configuration of a lens;

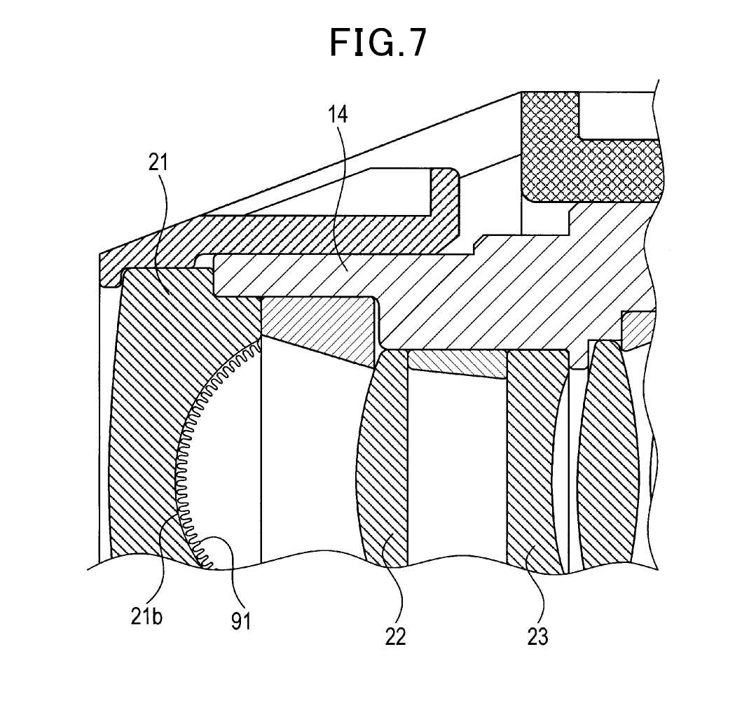

FIG. 7 is a cross sectional view showing an upper portion in the front part of the imaging device; and

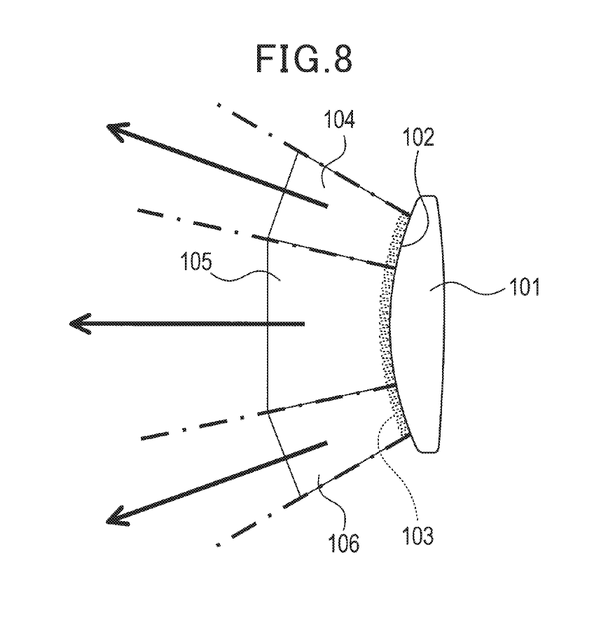

FIG. 8 is side view showing a method of forming a lens.

### DETAILED DESCRIPTION OF PREFERRED EMBODIMENTS

With reference to the drawings, embodiments of the present disclosure will be described.

### 1. Embodiment

### 1-1. Overall Configuration

An imaging device 1 shown in FIG. 1 is used as being mounted on vehicles such as cars and railroad vehicles. In the following description, a front direction is defined as a direction where the object exists with respect to the imaging device 1, and a rear direction is defined as a direction where the imaging device 1 exists with respect to the object. These front and rear directions are used for convenience only, and do not limit usage or configuration of the imaging device 1.

The imaging device 1 is provided with an imaging element 11, a first lens 21, a second lens 22, a third lens 23, a fourth lens 24, a fifth lens 25, an IR cut filter 26, and a cover glass 27. Also, the imaging device 1 includes a first gap ring 31, a second gap ring 32, a third gap ring 33, a retainer 16 and a housing 12. The imaging element 11 is configured to capture an object and output an image signal showing an image of the object. The first lens 21, the second lens 22, the third lens 23, the fourth lens 24 and the fifth lens 25, the IR cut filter 26 and the cover glass 27 are disposed on a light transmission path of light that reaches the imaging element 11. The first gap ring 31, the second gap ring 32, the third gap ring 33, the retainer 16 and the housing 12 are arranged so as to enclose the light transmission path of light arriving in the imaging element 11.

The above-mentioned light transmission path refers to a region through which the light reaches the imaging element 11 from the object. The imaging element 11 is mounted on an electronic circuit board 13. The above-described cover glass 27 is disposed on a front surface of the imaging element 11.

The above-described plurality of lenses and a plurality of gap rings are attached to the lens barrel 14. In the lens barrel 14, the first lens 21, the first gap ring 31, the second lens 22, the second gap ring 32, the third lens 23, the fourth lens 24, the third gap ring 33, and the fifth lens 25 are arranged in this order from the front side of the imaging device 1. These parts are fixed by a lens cap 15 which is attached to the lens barrel 14 from the front side of the lens barrel 14, and the retainer 16 which is attached to the lens barrel 14 from the rear side of the lens barrel 14. The retainer 16 corresponds to a barrel.

A first lens 21 is configured as a recessed meniscus lens of which the front surface has smaller curvature than that of the rear surface. The second lens 22 is configured as a plano-convex lens having a curved surface in the front side. The third lens 23 is configured as a plano-concave lens having a curved surface in the rear side. The fourth lens 24 is configured as a biconvex lens of which the front surface has smaller curvature than that of the front surface. The fifth lens 25 is configured as a biconvex lens of which the front surface has larger curvature than that of the front surface.

The IR cut filter 26 is a flat plate-like filter. The cover glass 27 is a flat plate-like glass. It should be noted that the front surfaces of the above-described each lens, the IR cut filter 26 and the cover glass 27 serve as incident surfaces from which light enters inside thereof, and the rear surfaces serve as emitting surfaces from which light is emitted towards outside.

The housing 12 holds an electronic circuit board 13 and a lens barrel 14, thereby holding the above-described lenses, the gap rings, the retainer 16, and the imaging element 11. The housing 12 holds the IR cut filter 26 between the fifth lens 25 and the cover glass 27.

It should be noted that each lens, the IR cut filter 26, and the cover glass 27 correspond to transparent members. In the following description, each of these parts is simply referred to as a transparent member. The imaging device 1 has a moth-eye structure on at least one surface among the above-described transparent members. The moth-eye structure has a plurality of protrusions in which each protrusion has a size smaller than the wavelength of visible light which ranges from 380 nm to 780 nm. The protrusions are arranged at predetermined intervals, where each interval is 100 nm or more and less than 250 nm, and each protrusion has a height of less than 250 nm. Therefore, the protrusions described above gradually produce a change in the refractive index macroscopically with respect to the incident light, whereby the light reflection can be reduced.

Hereinafter, an arrangement of the moth-eye structure in the imaging device 1 will be described. In FIGS. 1 to 8, the moth-eye structure is schematically illustrated. In other words, the ratios between other elements and the structure or the shape are not accurately illustrated.

### 1-2. Arrangement of Moth-Eye Structure

Examples of an arrangement of the moth-eye structure will be exemplified. For the imaging device 1, the moth-eye structure is not necessarily provided in the all objects capable of arranging the moth-eye structure as described below, but at least one object may have the moth-eye structure. The moth-eye structure may be formed on the entire surface of the object or on a part of the surface thereof.

<Arrangement of Moth-Eye Structure on a Plane>

In the above-described plurality of transparent members, in a transparent member which has a planar portion having a planar shape on at least either an incident surface or an emission surface of thereof, a moth-eye structure may be arranged on at least on a part of the planar portion.

For example, as shown in FIG. 1, a moth-eye structure 41 can be arranged on an incident surface and an emitting surface of the IR cut filter 26, an incident surface of the cover glass 27, for example. The moth-eye structure may be formed on both surfaces or one surface of the transparent member. Since the emission surface of the second lens 22 or the incident surface of the third lens 23 are planar surface, the moth-eye structure can be formed on these surfaces.

When forming the moth-eye structure on the planar portion of the transparent member, the moth-eye structure can readily be formed. This is because, in the case where the moth-eye structure is prepared separately from a body of the transparent member, and mounted to the body, when the mounting face of the body has a planar shape, the moth-eye structure can readily be mounted. For example, by using a sheet having a moth-eye structure formed thereon, and attaching the sheet to the planar surface, the transparent member having the moth-eye structure can be produced.

Also, in the case where the moth-eye structure is integrated to the body of the transparent member, since protrusions of the moth-eye structure extend in the same direction, the moth-eye structure can readily be formed.

<Arrangement of Moth-Eye Structure on Curved Surface>

The moth-eye structure can be arranged on each surface of the above-described lenses. The curved surface on which the moth-eye structure is arranged can be appropriately designed based on a degree of expansion and contraction which changes depending on the material of lens and the temperature when forming the lens.

Specifically, as shown in FIG. 2, a moth-eye structure 42 can be arranged on the incident surface 21a of the first lens 21. The moth-eye structure can readily be formed when being arranged on a surface of lens having relatively small curvature, compared to a case where the moth-eye structure is arranged on a surface lens having relatively large curvature. This is because the moth-eye structure can readily be formed on a planar surface as described above.

<Arrangement of Moth-Eye Structure on Opposed Plane>

The moth-eye structure can be arranged on surfaces satisfying the following conditions in the above-described plurality of transparent members.

(i) Two surfaces which face each other in adjacent two transparent members arranged in a direction where the light passes through

(ii) Each of the adjacent two surfaces has a planar shape

(iii) Adjacent two surfaces are parallel

According to the embodiment, as shown in FIG. 2, the emission surface 22a of the second lens 22 and the incident surface 23a of the third lens 23 satisfy the above-described conditions, and the moth-eye structure 43 is formed on the incident surface 23a.

Generally, surfaces which satisfy the above-described conditions are likely to cause a flare reflecting in the imaging device. Hence, since these surfaces are provided with moth-eye structures, flares can be prevented from being produced.

<Arrangement of Moth-Eye Structure on a Portion of Light Transmission Path>

The moth-eye structure can be arranged, among surfaces of the above-described transparent members, at least on a part of the light transmission path in which the light is transmitted and reaches the imaging element 11.

As shown in FIG. 3, among the surfaces of the transparent members, the moth-eye structure 44 can be arranged in a region defined between a path 51 indicating an upper edge of the light transmission path and a path 52 indicating a lower edge of the light transmission path, where the light is transmitted through the region to reach an area allowing the imaging device 11 to capture images. In the example of FIG. 3, the moth-eye structures 44 are formed on a region 22c which is a part of the incident surface of the second lens 22, a region 22d which is a part of the emitting surface of the second lens 22, and a region 25a which is a part of the fifth lens 25a.

Thus, no moth-eye structure is formed in a portion where no light passes through, whereby physical influence of the moth-eye structure when being formed, for example, strength of the surface of the transmission member, can be prevented from being lowered, and the manufacturing cost can be reduced.

The moth-eye structure may be arranged in a region where the light passes through, or may be arranged in a region where no light passes through.

<Arrangement of Moth-Eye Structure in a Portion where No Lens Cap and Gap Ring are Present>

As shown in FIG. 4, a part of an incident surface 21a of the first lens 21 comes into contact with the lens cap 15. In the first lens 21, a moth-eye structure 45 can be arranged in a portion to which the lens cap 15 does not come into contact. A part of the incident surface 22b of the second lens 22 comes into contact with the first gap ring 31. In the second lens 22, the moth-eye structure 45 can be arranged in a portion with which the first gap ring 31 does not contact.

Thus, the moth-eye structure is formed in a portion to which the lens cap 15 or the first gap 31 do not come into contact, whereby a physical influence when forming the moth-eye structure, for example, a decrease in a mounting accuracy of the lens, can be suppressed, and also manufacturing cost can be reduced.

It should be noted that the moth-eye structure may be provided in a portion to which the lens cap 15 and the first gap ring 31 do not come into contact, or may be provided in a portion to which the lens cap 15 and the first gap ring 31 come into contact.

### 1-3 Structure of Transparent Member Having Moth-Eye Structure

Structure of transparent member having moth-eye structure is not specifically limited. An example thereof will be described as follows.

<Integral Molding by Resin or the Like>

A lens may be formed with resin and a moth-eye structure can be integrally formed on the surface of the lens. Further, a moth-eye structure having no lens function may be integrally formed.

The material used for forming the lens and moth-eye structure is not limited to resin, but various materials can be used as long as an integral molding can be accomplished.

For example, as shown in FIG. 2, the moth-eye structure 42 formed on the first lens 21 and the moth-eye structure 43 of the third lens 23 may be formed by an injection molding using a metal mold. Thus, the moth-eye structure is integrally formed on the transparent member, whereby a change in the refractive index between a body part of the transparent member and the moth-eye structure can be reduced so that light reflection can be significantly reduced. The body part described here is necessary part for serving as a lens, excluding at least a moth-eye structure part in the lens.

<Combination of Glass and Resin Lens>

At least one or more above-described lenses can be formed with a combination of glass and lens member made of resin.

A lens 71 shown in FIG. 5 can be formed to include a glass 72 having a plate shape, and a lens member 73 made of resin and arranged on a surface of the glass 72. The lens member 73 has a plate shape on a surface 73a which contacts with the glass 72, and a curved shape on a surface 73b opposite to the surface 73a. In the lens member 73, a moth-eye structure 74 is formed on the surface 73b, so that the lens 71 has a moth-eye structure as a whole structure. A shape of the lens member 73 of the lens 71 can be changed to form, for example, a concave lens. Also, the lens member 73 can be arranged on both surfaces of the glass 72. The structure of the lens 71 can be applied to each of the above-described lenses of the imaging device 1.

Thus, the lens member having the moth-eye structure is attached to the glass member, whereby a lens having a moth-eye structure can readily be produced.

Also, in the lens 81 shown in FIG. 6, a resin film 84 having a moth-eye structure 83 is formed on a surface of the lens 82 which is made of glass. The resin film 84 and the moth-eye structure 83 may be formed on the entire surface of the lens 81, or formed on either one of surfaces of the incident surface or the emitting surface of light. It should be noted that the structure of the lens 81 can be applied to each of the above-described lenses of the imaging device 1.

### 1-4. Configuration and Method for Smoothly Performing a Punching

<Moth-Eye Structure Formed of Resin Having High Flexibility>

It is considered that a moth-eye structure can be formed on a lens having a curved shape on either the incident surface or the emission surface, by using resin having higher flexibility than that of the body part of the lens. The body part described refers to a necessary part for serving as a lens, excluding at least a moth-eye structure part in the lens.

For example, as shown in FIG. 7, in the case where a moth-eye structure 91 is formed on a surface having larger curvature like an emission surface 21b of the first lens 21, the moth-eye structure 91 can be formed by using resin which is softer than the body part of the first lens 21.

For example, the body part of the first lens 21 can be formed of glass, and the moth-eye structure 91 can be formed of resin which is softer than glass such as cycloolefin polymer, polycarbonate and polyester

The first lens 21 is thus formed, whereby a punching of the moth-eye structure 91 can be performed smoothly in a punching process when the first lens 21 is molded.

<Division of Mold>

As shown in FIG. 8, when forming the moth-eye structure 103 by molding on a surface 102 of the lens 101, a plurality of molds 104 to 106 can be used for the molding. Thus, when forming the moth-eye structure 103, since the directions of the punching can be changed for each of the molds 104 to 106, directions of the protrusions of the moth-eye structure 102 can be changed.

<Punching of Flexible Moth-Eye Structure>

In the case where the portion of the moth-eye structure is made of a material in which the flexibility changes depending on a condition, the punching can be performed under a condition where the flexibility is high. For example, in the case where the moth-eye structure is formed of a material in which the flexibility becomes higher at a predetermined temperature, the punching can be performed under the predetermined temperature condition.

### 1-5. Moth-Eye Structure Included in a Member Other than Transparent Member

As shown in FIG. 1, a moth-eye structure 111 may be formed on an inner periphery and the retainer 16 and the first gap ring 31.

According to the above-described configuration, light reflection can be prevented from occurring in the inner periphery of the retainer 16 and the first gap 31.

### 1-6. Effects

According to the above-described embodiments, the following effects can be obtained.

(1a) Since the imaging device 1 has a moth-eye structure on the transparent member as an optical system, light reflection on the incident surface and the emission surface of the transparent member can be suppressed. Hence, a captured image of the object indicated by an image signal outputted by the imaging device can be an image having high quality in which ghost and flares are reduced. The imaging device 1 is mounted on a vehicle so that ghost and flares are likely to occur. However, since ghost and flares are suppressed as described above, noise in the captured image can be reduced. Therefore, in the case where obstacles and road signs have to be recognized using captured image, recognition accuracy can be enhanced.

(1b) In the imaging device 1, the transmittance of the lens is risen due to the moth-eye structure so that the sensitivity can be higher.

(1c) In designing lenses, a trade off relationship is present between countermeasure against flares and the resolution thereof. However, the moth-eye structure reduces light reflection so that degree of the required countermeasures against flares can be lowered. Hence, the imaging device 1 is designed so as to improve the resolution. Further, the lens can be designed in various way such that the number of lenses can be reduced and a use of an aspherical lens can be avoided.

(1d) The imaging device 1 has the moth-eye structure 111 on the surface 102 possibly even in the retainer 16 and the first gap ring 31. Hence, ghost and flares can be significantly reduced.

### 2. Other Embodiments

Embodiments of the present disclosure are described so far. The present disclosure is not limited to the above-described embodiments. However, the embodiments can be modified in various ways.

(2a) According to the above-described embodiments, configurations are exemplified in which moth eye structures are arranged on respective lenses attached to the lens barrel 14, the IR cut filter 26, and the cover glass 27. However, positions of the moth-eye structure are not limited to the above-described configuration. For example, in the case where the imaging device has on-chip lens, moth-eye structure may be formed on the surface thereof.

(2b) An imaging device having a plurality of lenses may have a moth-eye structure on only a surface of a resin-made lens.

(2c) According to the above-described embodiments, a configuration having the IR cut filter 26 is exemplified. However, a configuration having other type of filters such as low-pass filter may be employed.

(2d) A plurality of functions included in a single element of the above-described embodiments may be achieved by a plurality of elements, or one function included in a single element may be achieved by a plurality of elements. A plurality of functions included in a plurality of elements may be achieved by a single element, or a function achieved by a plurality of elements may be achieved by a single element. Also, a part of configurations of the above-described embodiments can be omitted. At least part of the above-described configuration may be added to other configuration of the above-described embodiments, or may replace other configuration of the above-described embodiments. It should be noted that various aspects inherent in the technical ideas identified by the scope of claims are defined as embodiments of the present disclosure.

(2e) Other than the imaging devices described above, the present disclosure can be achieved in various ways such as a transparent member which is an element of the imaging device, or a manufacturing method of the transparent member.

What is claimed is:

1. An imaging device mounted on a vehicle comprising:
an imaging element configured to capture an object and output an image signal of the object;
a plurality of transparent members including at least one lens, arranged on a light transmission path of light that reaches the imaging element; and
a housing configured to hold the imaging element and the plurality of transparent members, wherein
a moth-eye structure is arranged on at least one surface among the plurality of transparent members.

2. The imaging device according to claim 1, wherein
at least one of the plurality of transparent members includes a planar portion having a planar shape on at least either an incident surface or an emission surface of light, at least part of the planar portion having the moth-eye structure.

3. The imaging device according to claim 1, wherein
at least one lens has a curved shape portion on a surface thereof, the curved portion having the moth-eye structure.

4. The imaging device according to claim 1, wherein
among the plurality of transparent members, at least one pair of two adjacent transparent members arranged in a direction where the light passes through, includes a planar shape on each of two surfaces which face each other, and the two surfaces are parallel; and
the moth-eye structure is formed on at least a part of the two surfaces which face each other.

5. The imaging device according to claim 1, wherein
at least one of the plurality of transparent members includes the moth-eye structure on at least a part of the light transmission path of light that reaches the imaging element.

6. The imaging device according to claim 1, wherein
at least one of the at least one lens comes into contact with at least either a lens cap or a gap ring; and
the moth-eye structure is formed on at least a part of a portion with which the lens cap and the gap ring do not contact.

7. The imaging device according to claim 1, wherein
at least one of the at least one lens includes a glass having a plate shape, a lens member made of resin arranged on a surface of the glass; and
is the moth-eye structure is formed on the lens member.

8. The imaging device according to claim 1, wherein
at least one of the at least one lens is formed of a glass; and
the moth-eye structure is formed on at least one surface of either the incident surface or the emission surface.

9. The imaging device according to claim 1, wherein
at least one of the at least one lens has a curved shape on at least one surface of either the incident surface or the emission surface; and
the moth-eye structure is formed on the surface having the curved shape, the moth-eye structure being formed of resin having higher flexibility than that of a body part of the lens.

10. The imaging device according to claim 1, wherein
at least one of the at least one lens is formed of resin; and
the moth-eye structure is formed, integrally with the lens, on a surface thereof.

11. The imaging device mounted on a vehicle comprising:
an imaging element configured to capture an object and output an image signal of the object;
at least one lens arranged on a light transmission path of light that reaches the imaging element;
at least one of either a barrel or a gap ring, arranged surrounding the light transmission path; and
a housing configured to hold the imaging element, the at least one lens, and at least one of either the barrel or the gap ring, wherein
a moth-eye structure is arranged on an inner surface of at least one of either the barrel or the gap ring.

12. The imaging device according to claim 1, wherein
the moth-eye structure has a plurality of protrusions arranged at predetermined intervals, each interval being 100 nm or more and less than 250 nm; and
each of the plurality of protrusions has a height of less than 250 nm.
